(19) United States
(12) Patent Application Publication
(10) Pub. No.: US 2012/0066202 A1
(43) Pub. Date: Mar. 15, 2012

(54) Method and apparatus for enhancing search results by extending search to contacts of social networks

(76) Inventors: Mari Hatazawa, Torrance, CA (US); Mike Iao, Torrance, CA (US); Andrew De Silva, Torrance, CA (US)

(21) Appl. No.: 13/136,190

(22) Filed: Jul. 26, 2011

Related U.S. Application Data
(60) Provisional application No. 61/367,774, filed on Jul. 26, 2010.

(51) Int. Cl. G06F 17/30

(52) U.S. Cl. 707/710; 707/E17.108

(57) ABSTRACT

A information search method extends to a social networking site to search information by a contact name and other elements as location-based information, relationship, product, etc. The method includes the steps of receiving a search term specified by a searcher, detecting whether WHO is specified in the search term to determine whether search should extend to human contacts in social networking services, identifying WHAT from the search term and determining a nature of WHAT from the search term; sending the search term to a social networking service to retrieve relevant information; and presenting the retrieved information arranged in a predetermined order on a display or by audible sound and optionally a geographic information to retrieve information.

### CROSS-REFERENCE TO RELATED APPLICATION

This application claims priority to provisional application No. 61/367,774 filed Jul. 26, 2010, the disclosure of which is hereby incorporated by reference herein in its entirety.

### FIELD OF THE INVENTION

This invention relates to an information retrieval system, and more particularly, this invention relates to a search method and apparatus using various contacts (human contacts in an address book, email, and social network, etc.) as a means to find location, objects, people and relationship related to the contacts.

### BACKGROUND OF THE INVENTION

A search engine is designed to retrieve information in large scale, diverse and growing corpuses through a network such as Internet. The search results are usually presented on a monitor screen in a list of results that are commonly called “hits”. The information retrieved may consist of web pages, images, text information, and other types of files. With the remarkable advancement in the information technology, the search engines today can quickly retrieve specific information that match the terms of queries.

Web search engines are operated by storing information in web pages, which can be retrieved by a web browser or a web crawler (sometimes also known as a spider)—an automated web browser which follows every link on the site. The contents of each page are then analyzed and indexed, which allows the contents to be found as quickly as possible. Moreover, an index database is configured to store the contents of the web pages for quick search for later queries. Some search engines store all or part of the source page (referred to as a cache) as well as information about the web pages, whereas others store every word of every page they find.

However, current search systems do not utilize relationships associated with contacts in combination with location sensitive information to provide more relevant results. For example, U.S. Pat. No. 7,716,223 to Haveliwala et al. discloses a search engine providing personalized rankings of search results. This patent proposes that such a search system allows a user to variably adjust the degree to which his or her personal interests influence the presentation of results of a given search query. However, the technology of Haveliwala et al. does not disclose anything associated with utilizing contact in the social networks in combination with location sensitive information to provide more relevant results.

U.S. Pat. No. 7,636,779 to Hayashi et al. discloses a system and method directed to managing contextual based mobile searches. More particularly, the patent of Hayashi et al. discloses the idea of performing contextual mobile searches based, at least in part, on social networking information, including vitality information for a social network. Like Haveliwala et al. noted above, Hayashi et al. do not teach anything related to utilizing contact in the social networks in combination with location sensitive information to provide more relevant results.

U.S. Pat. No. 7,464,075 to McSherry et al. discloses methods and systems for efficiently computing personalized rankings of web pages or other interconnected objects. Moreover, the personalized rankings are produced by efficiently computing an approximation matrix to an ideal personalized page ranking matrix. However, like Haveliwala et al. and Hayashi et al. noted above, the patent of McSherry et al. does not disclose anything associated with using contacts in the social networks to enhance search results.

Therefore, there is a need for a new and improved method and apparatus to provide more relevant and human context-based search results by incorporating contact names into the search term to further retrieve information pertaining to the content of the user specified by a contact name and human relationships related to the user.

### SUMMARY OF THE INVENTION

It is therefore an object of the present invention to provide a method and apparatus to enhance search results by incorporating human context or human relationship information, instead of solely searching general indexes.

It is another object of the present invention to provide a method and apparatus to enhance search results by incorporating a user's information such as user's identity, preference, social networks, etc. with the search terms.

It is still another object of the present invention to provide a method and apparatus to enhance search results by incorporating a contact name (“WHO”) with a generic search term (“WHAT”) such as location, object, etc., such that the search results are associated with the searcher's preference and human relationships.

It is a further object of the present invention to provide a method and apparatus to enhance search results by creating a situation in which members of social networking service respond to a search request in real time in a visible manner by sending location-based information.

In one aspect of the present invention, a method for enhancing search results may include the steps of receiving a user's search term including a WHO element and a WHAT element; collecting the contact's information including the contact's identity, preference and social networks; collecting information regarding the generic search term; aggregating and reorganizing the information of both the contact and the generic search term; and displaying the aggregated search results.

In one embodiment, the step of collecting the contact's information may include the step of determining whether the contact is one of the members in the searcher's social networks. In another embodiment, the step of determining whether the contact is one of the members in the searcher's social networks includes the step of determining a level of trust between the user and the member.

In still a further embodiment, the step of aggregating and reorganizing the information of both the contact and the generic search term may include the steps of determining the searcher's current location and prioritizing the search results according to the searcher's current location.

According to the present invention, the search method and apparatus makes use of various contacts, i.e., human contacts in an address book, email, and social network, etc., as a means to find location, objects, people and relationship related to the contacts, thereby enhancing the search results. Namely, the search result is enhanced by incorporating human context or human relationship information, instead of solely searching general indexes. The search result is further enhanced by incorporating a user's information such as user's identity, preference, social networks, etc. with the search terms. More specifically, the search method and apparatus incorporates a contact name (“WHO”) with a generic search term (“WHAT”) such as location, object, etc., such that the search results are associated with the searcher's preference and human relationships. In a further aspect, the search method and apparatus creates a situation in which members of social networking service respond to a search request in real time in a visible manner by sending location-based information. Thus, in the present invention, it is possible to obtain more relevant and human context-based search results by incorporating the contact names into the search term to further retrieve information pertaining to the content of the user specified by the contact name and human relationships related to the user.

The present invention together with the above and other advantages may best be understood from the following detailed description of the embodiments of the invention illustrated in the drawings below.

### BRIEF DESCRIPTION OF THE DRAWINGS

FIG. 1 is a schematic diagram showing a generic configuration of the information network including a social network for implementing the present invention.

FIGS. 2A and 2B are schematic diagrams showing structure of a social network where FIG. 2A shows a basic structure of a social network and FIG. 2B shows a hierarchical aspect of a social network.

FIG. 3 is a schematic view of the present invention showing relationships among the contacts for retrieval of information when utilizing “contact name plus location-based entity” as a search method.

FIGS. 4A and 4B are display examples on an electric device showing a list of entries that are retrieved as a result of conducting the search method of FIG. 3 where FIG. 4A shows an example in which entries by specified contact person is given the highest priority, and FIG. 4B shows an example in which a contact filter is applied to find only selected contact's entries.

FIG. 5 is a schematic view of another embodiment of the present invention showing relationships among the contacts when utilizing “contact name plus relationship category” as a search method.

FIG. 6 is a schematic view of a further embodiment of the present invention showing relationships among the contacts when utilizing “contact name plus object” as a search method.

FIG. 7 is a schematic diagram showing a basic configuration of information search system including networks, user devices, and servers under which the present invention is implemented.

FIG. 8 is a block diagram showing an example of basic configuration of an electric device or a user device that is used for connecting to Internet and social networking services for conducting the information retrieval under the present invention.

FIG. 9 is a flow chart showing the steps of retrieving information utilizing social networking service under the present invention that performs information retrieval based on WHO and WHAT element of a search term.

FIG. 10 is a flow chart showing another example of operational flow for retrieving information via social networking service under the present invention with more detailed steps than the example of FIG. 9.

FIG. 11 is a schematic view of a further embodiment of the present invention showing the situation where members of social network are communicating in real time for sending the location-based information.

FIG. 12 is a flow chart showing the steps of retrieving information utilizing social networking service under the present invention in the situation of FIG. 11 where friends are providing requested location-based information in real time.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

This invention relates to an information retrieval system and method via communication networks. More specifically, this invention relates to a search method and apparatus for using a contact name in a user's social networks as a mean to find location, people and relationship between some objects with the contact. In addition to the current search method using key words or key queries in which a search engine retrieves specific information that match the terms of keys words or queries, the present invention is able to dramatically expand the search area by using the contact information in its search operation.

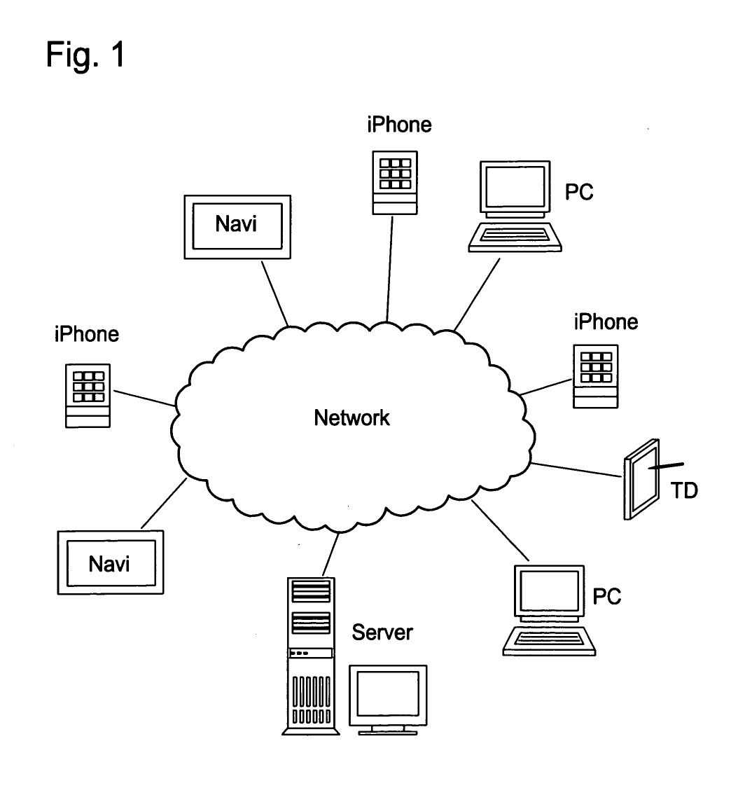

FIG. 1 is a schematic block diagram showing a basic configuration of the information network including a social network for implementing the present invention. Various users and service providers are connected to the information network wirelessly or with wire to retrieve and exchange information. Users operate their electric devices (user devices) to input search queries and retrieve the resultant information in a text and graphic format.

Such electronic devices include personal computers, smart phones such as iPhone (by Apple Computer, Inc., California), navigation devices, tablet devices TD, etc. Various service providers or servers are also connected to the information network to provide unique functions and information to the users via the information network. Such service providers include a web search service provider and a social network service provider that is directly related to the present invention. With the remarkable advancement in the information technology, the search engines today can quickly retrieve and display specific information that match the terms of queries.

Recently, social networking service websites, such as Facebook, MySpace and Twitter, etc., allow users to interact or socialize with other users. A social network is a social structure made of nodes (which are generally users or organizations) that are tied by one or more specific types of interdependency, such as values, visions, ideas, financial exchange, friendship, and/or trade. A social networking service is an on-line (i.e., Web, Internet, etc.) site that provides a virtual community for on-line users (i.e., user members).

Such social networking service users interact and communicate with one another via blogging, instant messaging, posting messages, e-mailing, etc., about shared interests and points of discussion. Social network service concepts and features are described in U.S. Patent Application Publication No. 2005/0177385 (entitled “Method and System for Customizing Views of Information Associated with a Social Network User”) by Hull et al., which is hereby incorporated by reference in its entirety.

Each user of a social network site is required to show a user profile in which a user provides general and personal information of the user to the network. For example, a user profile may include: aliases; contacts (e-mail address, etc.); residence; age; interests (sports, religion, hobbies, etc.); occupation; gender; marital status; list of other users of the social network site who are friends, family, co-workers, colleagues, etc.; on-line and off-line group memberships or affiliations; strength of relationships with other users of the social network site; etc.

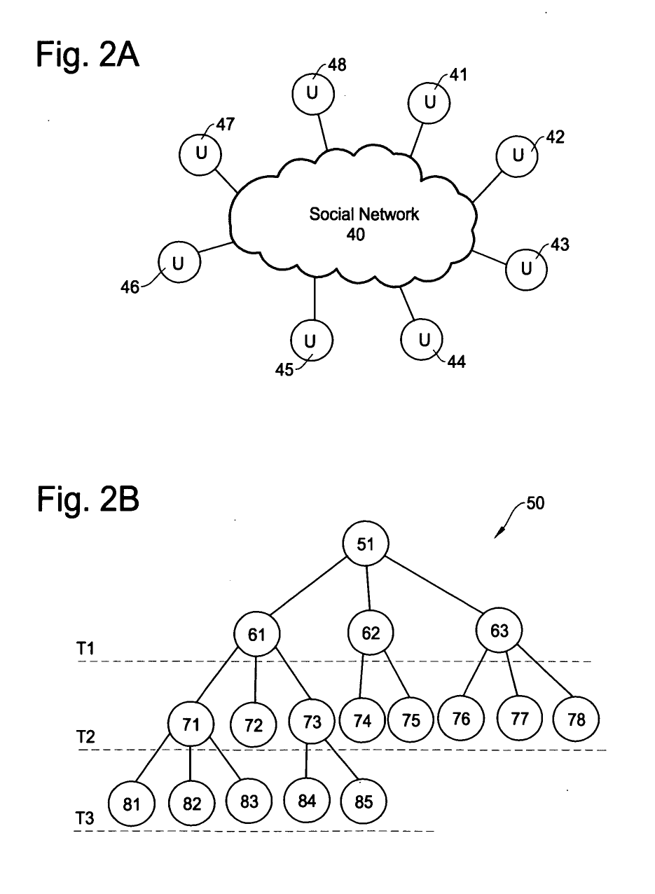

As can be seen in FIG. 2A, a plurality of users 41 to 48 may subscribe to a social network service website 40 and interact with each other via the social network service website 40. For example, the subscribed user can share his/her current status, send emails, upload pictures, music and video, and discuss some topics with other users via the social network 40. Also, in a typical social network service, the users are allowed to form or join one or more groups in the social network website 40.

Such a group is a subset of users of a social network which shares a common association such as interest or aim to act together. For example, a group may include alumni of the same school, fans of the same baseball team, or people with same hobbies or interests. Membership in a group is sometimes open to all members of the social network, but under some circumstances, a member of the social network needs to apply to a group administrator to receive permission or recommendation to join the group.

Some popular social network services present the details of interactions as a hierarchical relationship between specific members. Such an example is shown in FIG. 2B in which the circles represent specific members (user's of a social networking service), and the solid lines represent personal relationships between such members. In FIG. 2B, a member 51 is the member relative to whom the relationships of other members 61-63 are directly referenced, i.e., the members 61 to 63 belong to a tier 1 (T1), a first layer, in relation to the member 51.

Likewise, members 71 to 78 occupy a tier 2 (T2), i.e., a second layer, and members 81 to 85 occupy a tier 3 (T3), i.e., a third layer, in relationship with the member 51, although the hierarchy shown in FIG. 2B is not absolute. Generally speaking, each member in the social network has an associated hierarchy of personal relationships with specific subsets of other members in the social network. It is noted that, relative to a specific member, the vast majority of members may have no significant relationship beyond the membership in the common social network.

In some social network services, the personal relationships shown in FIG. 2B are characterized by levels of friendship. For example, the members 61 to 63 in the tier T1 are friends of the member 51, meaning that the member 51 has a direct relationship, often characterized by a high level of trust, with each of the members 61 to 63. In general, establishing a friendship between two or more members entails mutual agreement between the two or more members in the social networking service.

For example, the initially member 51 invites the member to become a friend, and the member 61 accepts the invitation, thus, the member 51 and the member 61 become friends. Note that a member has the option to decline or postpone to answer the invitation to form a friendship. As discussed below, friends of a specific member may have access to special privileges not available to other members of the social network.

Unlike the direct friend, a member in the tier T2 is referred to as a friend-of-a-friend of the member 51, i.e., indirect friend. For example, the member 61 is directly known by the member 51, so the member 61 is a friend of the member 51. In contrast, a member 71 is not directly known by the member 51, so the member 71 is not a friend of the member 51. The member 71 is, however, directly known by the member 61, so the member 71 is a friend of the member 61, and a friend-of-a-friend of member 51.

Thus, the member 61 is a common friend of the member 51 and the member 71, who may play significant roles for expanding the group in the social networks. For example, the member 61 may introduce a member 73 to the member 51 and ask the member 73 to provide assistance to the member 51. Similarly, a member in the tier T3 is a friend-of-a-friend-of-a-friend of the member 51 where members 81-85 are not directly known by the member 51 or the member 61 but they are directly known by the member 71 or 73.

As noted above, the present invention relates to a search method and apparatus for using a contact name in a social networking service as a mean to find a location-based entity, people and relationship between some objects with the user specified by the contact name. The conventional information retrieval systems do not utilize the relationships associated with users of social networking services in combination with location-sensitive information to provide more relevant results. Namely, the conventional system searches information via Internet or Web, etc., but does not consider or utilize the relationships and associated information among the users belongs to the searcher's social network.

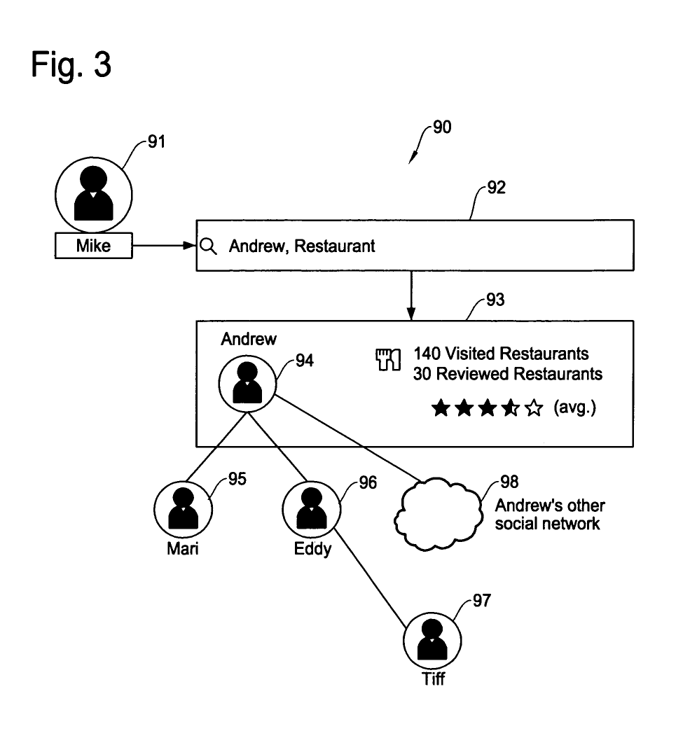

FIG. 3 is a schematic view showing an example of search method of the present invention which makes use of relationships among the contacts for retrieval of information. In this example, an information retrieval system 90 under the present invention allows a user to search information on a specific restaurant utilizing “contact name plus location-based entity” as a search method. More specifically, a searcher (Mike) 91 is currently in the city of Torrance and is looking for good Japanese restaurants in Torrance and he knows one of his friends in the social network, Andrew, is very familiar with all Japanese restaurants in Torrance.

With such general knowledge, the searcher 91 can simply search the web by inputting the search term “Andrew, restaurant” in an input field 92 of the information retrieval system 90. Thus, the information retrieval system 90 searches Andrew's social networks to provide the searcher more personalized, preferable and desirable search results. For example, the information retrieval system 90 may search certain social networking websites 93, such as Yelps, ZAGAT, Yahoo Local, etc. to retrieve Andrew's reviews or recommendations about the Japanese restaurants.

For example, the information retrieval system 90 may search Andrew's social networks 93 to retrieve information from direct friends 95 (Mari) and 96 (Eddy), and even a friend-of-a-friend 97 (Tiff) to look for more information about the Japanese restaurants. It is noted that since the friend 97 (Tiff) is not a direct friend of Andrew 94, his information may be only open to her direct friends with high level of trust. Further, the information retrieval system is configured to further search Andrew's other social networks (e.g. Facebook) 98 to find out more information about the Japanese restaurants.

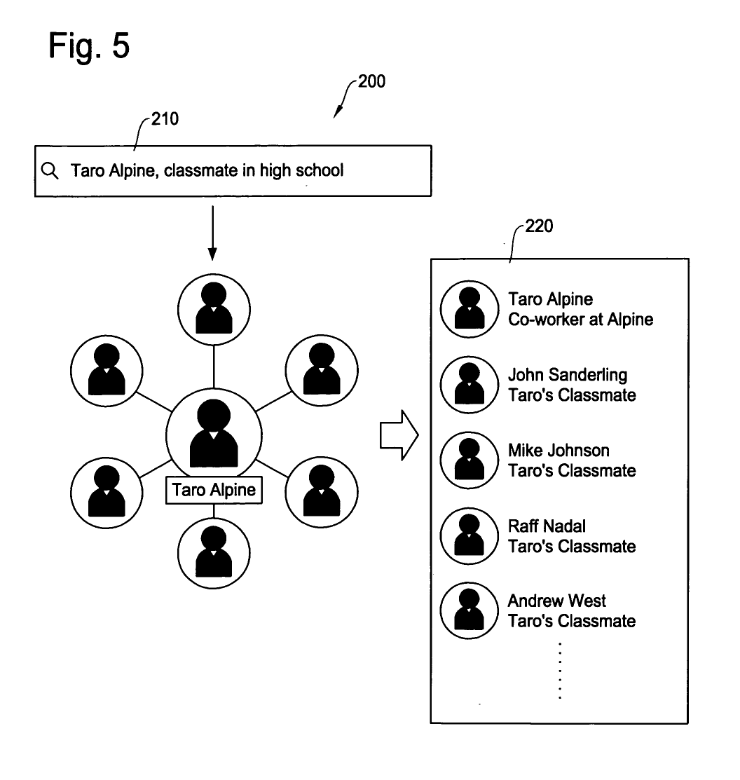

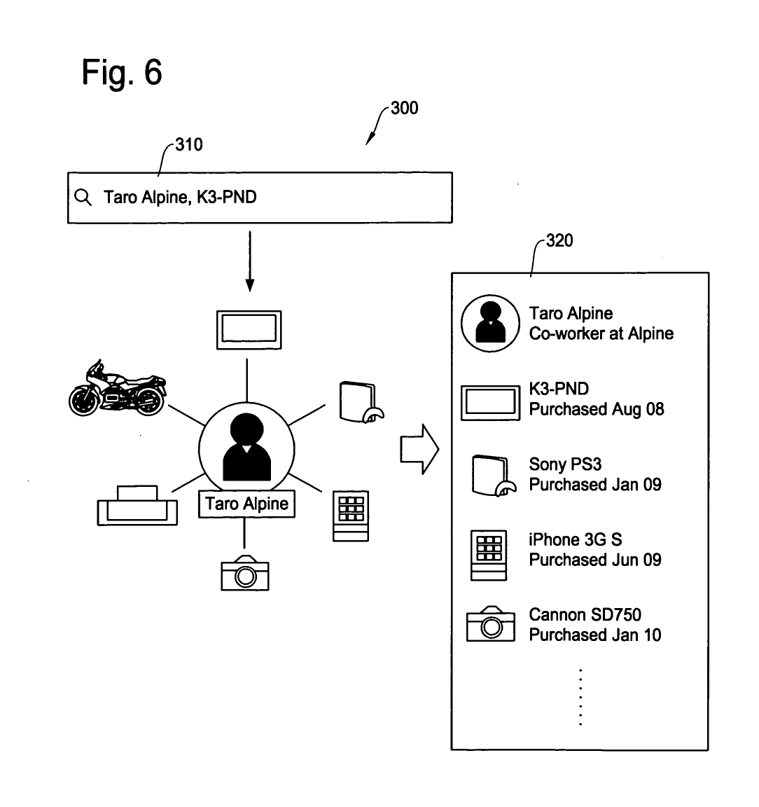

Furthermore, the search will keep spider web crawling until the last person who has no knowledge about a good Japanese restaurant in Torrance. Likewise, the searcher may search a contact and a location-based entity other than restaurants, such as co-workers in the same company, friends in common nail salons, nightclubs, spas, events and retailers, etc. In the embodiment of FIG. 3 as well as in embodiments in FIGS. 5 and 6 that will be described later, the user's search terms are parsed to find if there is a WHO element that defines a user of a social networking service that is known to the searcher, and a WHAT element that specifies a category/nature of search object belonging to the WHO element. Hereafter, the WHO element and the WHAT element may be represented simply by, for example, capitalized WHO and WHAT, respectively. Thus, inputting a contact name “Andrew” (“WHO”) and “restaurant” (“WHAT”) in the input field 92 of the information retrieval system 90, the information retrieval system 90 returns restaurants recommended by the specified person (Andrew).

In this example of FIG. 3, a contact name (Andrew) and a location-based entity (restaurant) are used as search terms to find restaurant information related to Andrew. In an alternative embodiment, location information of the searcher may be additionally used to retrieve relevant information. For instance, restaurants recommended by Andrew that are located near the searcher's location, such as Torrance, may be retrieved or prioritized.

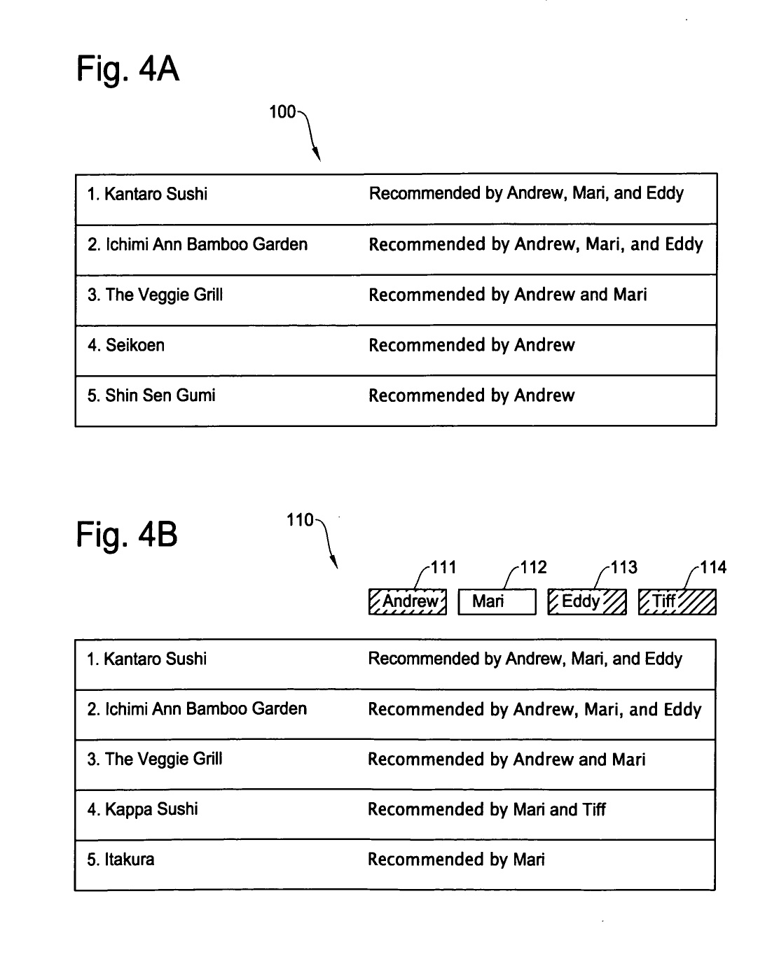

FIGS. 4A and 4B show display examples 100 and 110 that will be displayed by the information retrieval system 90 as a result of the search described above with reference to FIG. 3. In the example of FIG. 4A, a list of recommended restaurants are arranged by the member specified by the contact name (Andrew) as well as other members, i.e., direct and indirect friends of Andrew. For instance, the first restaurant “Kantaro Sushi” is recommended by Andrew, Mari and Eddy. Preferably, the recommended restaurants are arranged in the order that reflects the number of members (users) that recommend the particular restaurant.

In the case of search terms shown in FIG. 3, since the searcher has specified the contact name Andrew, the recommendation by Andrew is given the highest priority. Thus, in FIG. 4A, the restaurants that are recommended by Andrew are listed in the order of the number of users that recommend the restaurants. Further, in calculating the weight of recommendation, it is preferable that the recommendation by the user specified by the contact name, in this case, Andrew, may be assigned a higher coefficient compared to recommendations by other members.

The display example 110 of FIG. 48 shows a list of restaurants similar to that shown in FIG. 4A, but a contact filter has been applied to find only selected contact's recommendations. In the display example 110, the contact name buttons 111, 112, 113, and 114 are respectively provided, each of which represents a respective contact name (including the first contact and direct and indirect friends of the first contact). Here, the contact name button 112 representing that the recommendation of the friend “Mari” is enabled while others are disabled by the user, since, for example, the searcher (user) knows in some way that “Mari” is a Japanese and her recommendation on Japanese restaurants would be more reliable than others.

Thus, in this example, the list of recommended Japanese restaurants shows that all of the restaurants are recommended by “Mari”. A user may select a plurality of contact name buttons to display restaurants that are recommended by those contacts. In either examples of FIGS. 4A and 4B, the searcher may select one of the entries to view more detailed information regarding the selected entry or save the information. The searcher may set the selected entry as a destination for route calculation and guidance from the current location, i.e., the information retrieval system 90 of the present invention can be implemented in a navigation system.

In another embodiment shown in FIG. 5, an information retrieval system 200 is configured to retrieve information from the web when the search term is contact name plus relationship category. For example, when the user (searcher) wants to know more about a co-worker named “Taro Alpine”, the user can search the co-worker's high school classmate (relationship) by using a search term of “Taro Alpine, classmate in high school” in the input field 210. Consequently, the information retrieval system 200 can search the co-worker's social networks such as Facebook, Linkedin, MySpace, etc. to retrieve the information about the co-worker's high school classmates, results in a relationship list 220.

Other personal relationship categories may also be specified to retrieve people that are previously or currently related to the contact name. As stated above, the user may not be able to view detailed information or profile of each person in the relationship list 220 since some people may only allow direct friends to do so. In this manner, a contact name “Taro Alpine” (“WHO”) and “classmate in high school” (“WHAT”) to specify a personal relationship allows the information retrieval system 200 to return the list 220 of Taro's high school classmates.

Referring to a further embodiment of FIG. 6, an information retrieval system 300 is adapted to retrieve information from the web when the search term is “contact name plus object name”. For example, it is assumed that the user knows his/her co-worker “Taro Alpine” has a portable navigation device model K3-PND and wants to know more about what other devices, things, merchandise or products that Taro Alpine owns or has purchased. The user specifies a search term “Taro Alpine, K3-PND” in an input field 310 of the information retrieval system 300.

Accordingly, the information retrieval system 300 will search Taro Alpine's social networking service websites such as Facebook, MySpace, etc. as well as a local area network established within a company that Taro Alpine works. Thus, the information retrieval system 300 retrieves the product information shared by Taro Alpine, the results of which can be shown as a list 320 of product owned by Taro as shown in FIG. 6. If the user and the co-worker have similar interests or hobbies, he/she can find out more product information, product reviews and recommendations from the product list 320.

In this manner, a contact name “Taro Alpine” (“WHO”) and a product model “K3-PND” (“WHAT”) allows the information retrieval system 200 to return the product list 320 owned by Taro. Namely, the present invention determines “WHO” from a contact name, and determines the nature or category of “WHAT” to find relevant information from the social networking service. The searcher may select one of the product entries to read more detailed information such as product reviews or to purchase the product.

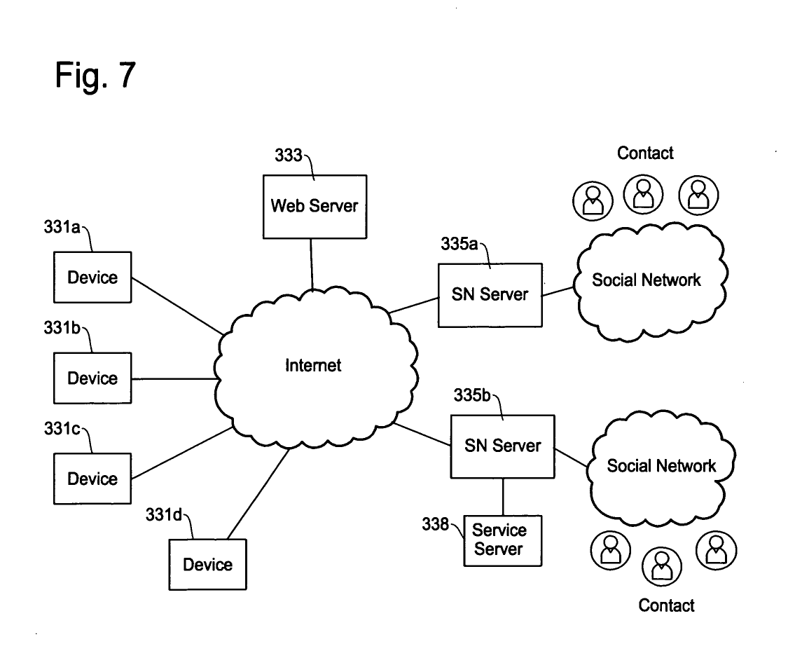

FIG. 7 is a schematic diagram showing a basic configuration of information search system including networks, user devices, and servers under which the present invention is implemented. FIG. 7 includes a plurality of user devices 331a-331d connected to a network (Internet), a web server 333, and social network servers 335a and 335b each providing a social networking service. FIG. 7 also shows a service server 338 which may be connected to the social network server 335 to assist searching operation of the present invention, and a plurality of contacts associated with corresponding social networks.

Each of user devices 331a-331d is an electronic device by which a searcher specifies a search word or term such as described above with reference to FIGS. 3, 5 and 6. The user devices 331a-331d can be a personal computer, a cellular phone, a tablet device, or a navigation system, etc. The user devices 331a-331d (hereafter collectively “user device 331”) are connected to the network (internet) and the web server 333 that helps to detect and deliver the information requested by the user. Each user device 331 is able to communicate with a social network service site (social networking (SN) server 335a or 335b) and the contacts of the social networks via the web server 333.

When the searcher inputs search terms, the method of the present invention in combination with the web browser on the user device 331 interprets the search terms and sends an appropriate query and instruction to Internet. Based on the query and instruction, the web server 333 detects an appropriate social network site (social networking server) 335 and promotes the communication between the user and the social network. For example, in the case described with reference to FIG. 3, the user device 331 interprets that Andrew is a name of a person and that restaurant is a location-based entity, and instructs the social networking server 335 to retrieve information on the restaurants recommended by Andrew, and optionally other restaurants recommended by users related to Andrew (friends).

Thus, the method of the present invention is capable of interpreting the search terms and sending an appropriate query and instruction for searching information not only in the conventional search areas but also in the social networks. The method of the present invention can be typically established in the user device 331 as noted above but can also be implemented by the service server 338 which is additionally provided to the social networking site 335. In this configuration including the service server 338, a part of the operation for searching is assigned to the service server 338 rather than the user device 331. The search term inputted to the device 331 is sent to the service server 338 and the social networking server 335 where the service server 338 runs an application program that interprets the search term and sends appropriate query and instruction to the appropriate social network site 335.

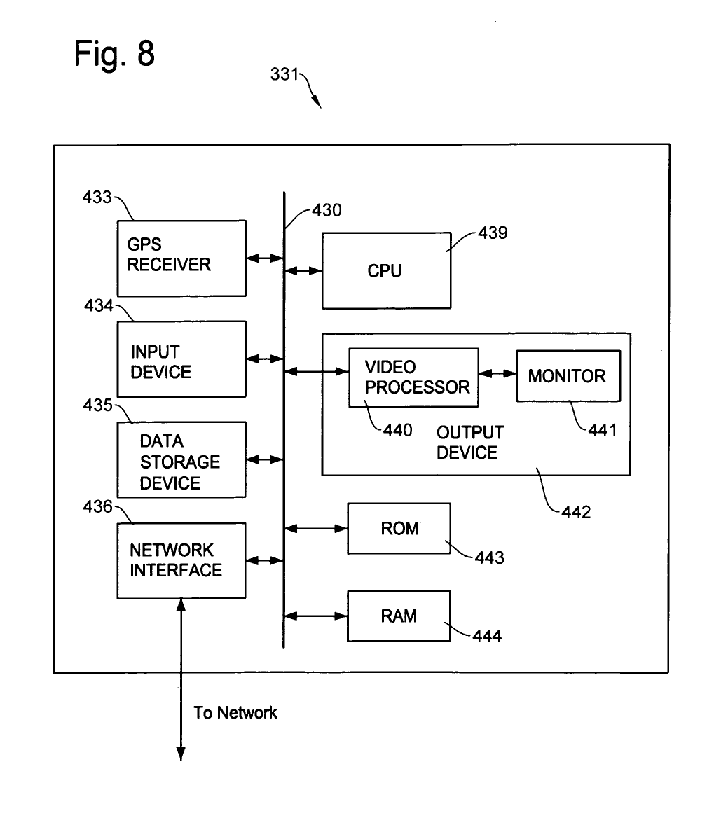

FIG. 8 is a block diagram showing an example of basic configuration of the user device 331 that is used by a user for information retrieval under the present invention. The device 331 preferably has a GPS receiver 433 that receives location information from satellites and map database (data storage device 435). Alternatively, other positioning system may be utilized such as mobile phone tracking that identifies a position by measuring power levels, antenna patterns and base stations.

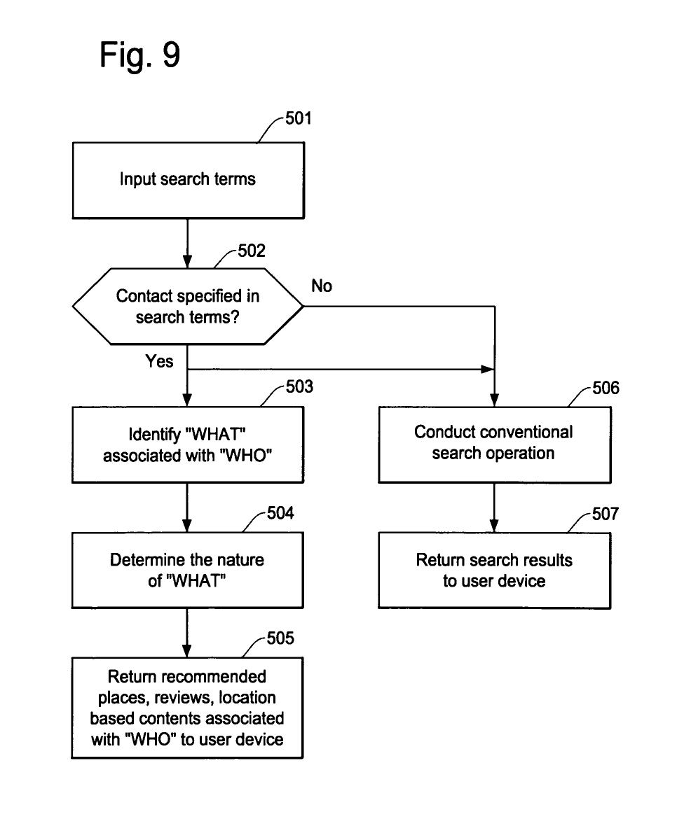

The data storage device 435 can be a hard drive, CD/DVD semiconductor memories, or a non-volatile storage. A program that performs the operation that will also be described with reference to the flow charts in FIGS. 9, 10 and 11 is typically stored in ROM 443 but can also be stored in the data storage device 435 as well. With respect to the present invention, the data storage device 435 may include a data table having a list of the searcher's (user's) social network contact names (“WHO” elements) that may be referenced and compared for extending the search operation to the information owned by such contacts and a list of categories (“WHAT” elements) of POIs (points of interest) and other objects.

An input device 434 is used to enter an instruction, information, selection of menus, etc., as well as a search term associated with the present invention, The input device 434 is typically a keyboard, a touch-screen, a remote controller, or a voice activation device, through which a searcher (user) inputs a search term. The network interface 436 is for connecting to an information network such as internet, and allows communication to and from a social networking service. The search term is sent to the network for query and its result is returned via the network interface 435.

A CPU 439 reads the program from the data storage device 435 or ROM 443 and executes the program to perform the operational steps for retrieving information, route navigation, etc. The CPU 439 controls an overall operation of the user device 331 including the search method of the present invention including the steps of interpreting a search term, determining if a contact name is specified in the search term, identifying the contact name and social network associated with the contact name, determining the nature of search object in the search term, sending the search terms to a social networking service, and retrieving the search results, etc.

An output device 442 is typically a monitor 441 that graphically displays the search terms by the user and the retrieved information from the networks. A video processor 440 is provided to produce video images and text information for the monitor 441. The output device 442 may also include a sound producing device. ROM 143 is for storing various control programs including the program of the present invention and other functions of the user device 331 and RAM 144 is for storing a processing result. A bus 430 is commonly provided for interfacing the above listed units (blocks) so that each unit communicates with one another.

FIG. 9 is a flow chart showing the basic steps of operational process for retrieving information utilizing the social networking services under the present invention. The steps of process described below are performed by executing a program that is read and executed by a computer (ex. CPU 439 in FIG. 8) of the user device and by manual operations of the user. In step 501, a searcher (user) inputs a search term or query, such as shown in FIGS. 3, 5 and 6 typically in the input field on the monitor screen of the user device 331. An input device such as a keyboard, a touch-screen, or a voice recognition device noted above with reference to FIG. 8 may be used in this step.

In step 502, the process checks whether a contact name is specified in the search term to determine whether the contact base search of the present invention should be conducted in addition to the traditional search. For example, “Andrew” is determined to be a contact name related to the searcher in the example illustrated in FIG. 3. In step 502, if a contact name is not included (“No”) in the search term, the process moves to step 506 to conduct a conventional search operation and produces a search result in a conventional way at step 507.

In contrast, in step 502, if a contact name is included (“Yes”) in the search term, the process moves to step 503 and identifies “WHAT” that is associated with the contact name “WHO” by further interpreting the search term. It should be noted that the present invention performs the contact base search in addition to the traditional search. Thus, even if it is determined that the contact name is specified (“Yes”) in the search term at step 502, the process also goes to the steps 506 and 507 to conduct the conventional search operation.

In the next step 504, the nature of the “WHAT” is determined to proceed the contact base search. The “WHAT” includes a location-based entity as described with reference to FIG. 3, a relationship type as described with reference to FIG. 5, an object name or products as described with reference to FIG. 6, etc. For example, “restaurant” is determined to be a location-based entity (WHAT) in the example illustrated in FIG. 3 since the searcher (Mike) in the particular location wants to know restaurants associated with the location.

In step 505, the process returns recommended places, reviews and location-based contents associated with the contact (“WHO”). Based on the “WHO” and “WHAT” elements noted above, the process extends the search area to various social networks associated with the searcher to retrieve the relevant information. The returned information will be provided to the searcher via an output device such as a monitor 441 (FIG. 8) in a manner shown in FIGS. 4A and 4B or a voice reproduction system that reads aloud the retrieved information.

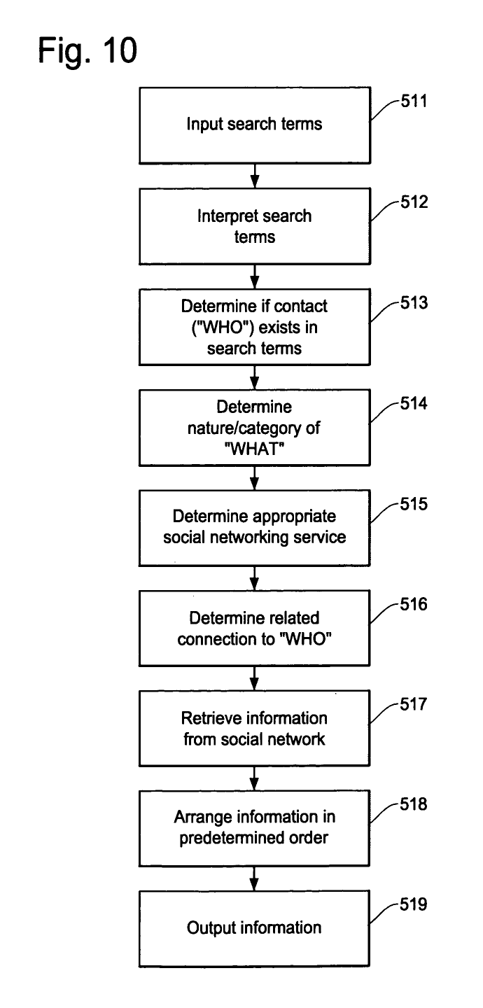

FIG. 10 is a flow chart showing an example of operational steps of the information retrieval method of the present invention. In particular, the flow chart in Figure shows more detailed steps of performing the search procedure described in the flow chart of FIG. 9 while the steps related to the conventional search process are omitted. In step 511, the searcher inputs a search term for performing a contact base search such as shown in FIGS. 3, 5 and 6 typically in the input field on the monitor screen. An input device 434 such as a keyboard, a touch-screen, or a voice recognition device and a monitor 441 noted above with reference to FIG. 8 may be used in this step.

In the next 512, the process interprets the search term and determines, in step 513, whether a contact name (“WHO”) exists that corresponds to the search term. A table having a list of the searcher's social network contact names may be referenced and compared for determining if the contact name (“WHO”) exists. Optionally, the information retrieval system may ask the searcher to select a contact name from a plurality of contact names if a plurality of candidate contact names exist that match the search terms.

In step 514, the procedure determines the nature of search object, i.e, “WHAT” or to which category the search term belongs. For instance, the category includes a restaurant, a retailer, a product', social relationship, etc. In this step, a data table having a list of categories and their components may be referenced to determine the nature of “WHAT”. Such a data table may be established in the data storage device 435 shown in FIG. 8. Optionally, the information retrieval system may ask the searcher to select a search category or type from a list showing a plurality of categories if a plurality of candidate categories exist for the same search term.

Having determined WHO and WHAT, in step 515, the process will determine one or more appropriate social network sites to retrieve the information. For example, if “WHAT” is determined to be a restaurant, the procedure will prioritize the information retrieval by searching a social network site that is strong in restaurant information. In step 516, the process will generate an appropriate query for the social networking service to retrieve relevant information from the social network. In this step, information provided by users related to WHO (ex., a friend of a friend) may also be searched if necessary.

In step 517, the process retrieves information from one or more specified social networking services. In this step, the process may crawl across the information to retrieve the relevant information not only from the contact (“WHO”) specified in the search terms but also from the related person of the specified contact such as described above with reference to FIGS. 3, 4A and 4B. In step 518, the process of information retrieval system will arrange the retrieved information by prioritizing the information so that more relevant information can be seen to the searcher.

Finally, in step 519, the retrieved information is output in a manner to be seen by the user. Preferably, the retrieved information is displayed on a monitor 441 of FIG. 8, but other output devices such as voice reproduction may also be used. Examples of manner that the retrieved information is presented are described and shown with reference to FIGS. 4A and 4B. The searcher may select one of the entries for more detailed information or for route calculation and guidance. The above described operational steps are performed by the user device 331, however, as described with reference to FIG. 7, the steps 512 to 518 may be performed by the service server 338 that is provided for the social networking service.

In addition to “WHO” and “WHAT” elements of the search term in the description above, an address (location) information may also be provided in the search term to retrieve more relevant information. For instance, a name of a city or zip code may be specified by the searcher in the input procedure. Alternatively, the user device 331 may have a positioning functionality such as a GPS receiver as shown in FIG. 8 and automatically provide location information such as geographic coordinates.

In such a case having a GPS capability, for example, search terms “Andrew”, “restaurant”, and a “current location” can be used to return a list of restaurants recommended by Andrew that are located in the vicinity of the current location of the searcher. Moreover, when the searcher performs the search while using a route guidance of a navigation system to reach a destination, the destination that has been set for the route guidance may be used to return a list of recommended restaurants to prioritize restaurant located in the vicinity of the destination.

Thus, the present invention allows the searcher to find relevant information by means of a social networking service, and in particular, by contact names of members (ex. friends) subscribing to the social networking service. The searcher may also solicit information from other users of the social networking service by simply inputting a few search terms. Thus, in the present invention, it is possible to obtain more relevant and human context-based search results by incorporating the contact names into the search term to further retrieve information pertaining to the content of the user specified by the contact name and human relationships related to the user.

In a further embodiment of the present invention, a contact base search can be conducted in real time in a visible manner when two or more contacts are connected to a social networking service. For example, when a user (member of a social network site, people in address book, etc.) realizes one of his/her friends (contacts) is currently looking for location-based information, the user can provide assistance to the friend by sending a message and recommendation to the friend. In this method, the user (searcher) may receive location-based information from his/her social networking service friends in a real time fashion by inputting a simple query.

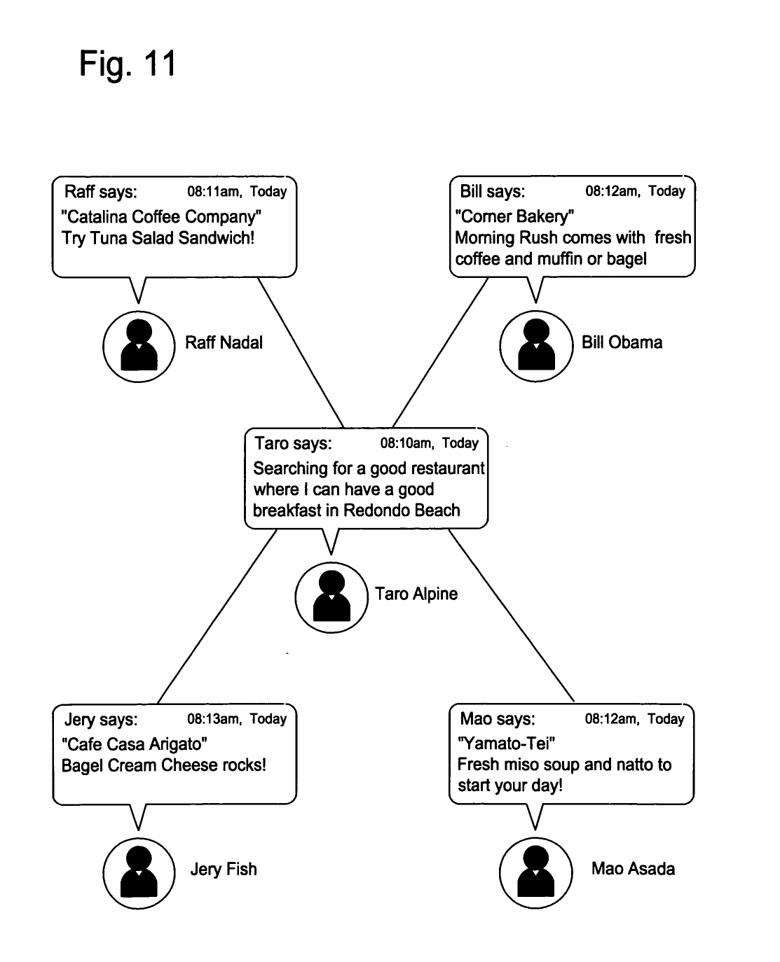

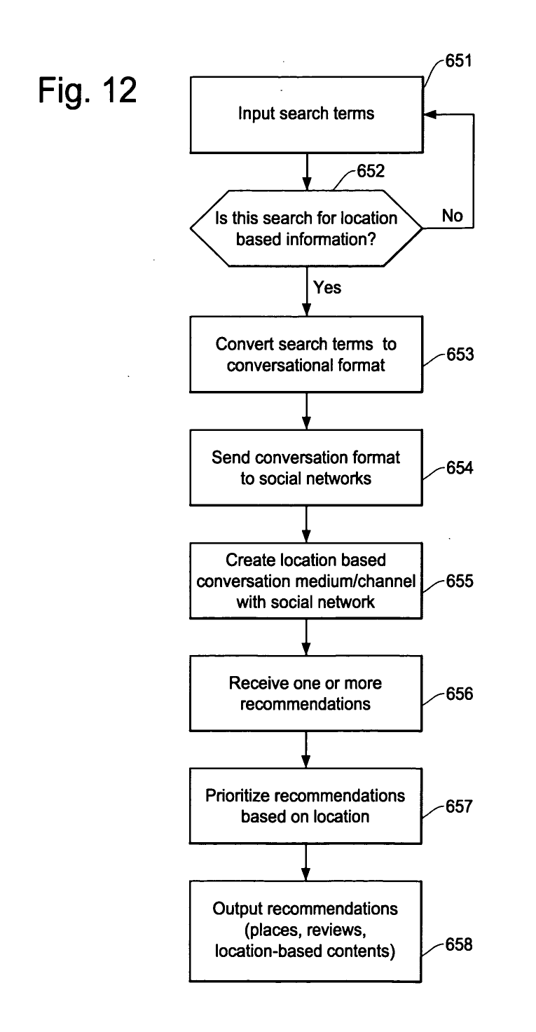

Such an example of real time information exchange through a social network, such as people in an address book, will be described with reference to FIGS. 11 and 12. FIG. 11 is a schematic view of a further embodiment of the present invention showing the situation where members of social network are communicating in real time for sending the location-based information. FIG. 12 is a flow chart showing the steps of retrieving information utilizing social networking service under the present invention in the situation of FIG. 11 where friends are providing requested location-based information in real time.

The example of FIG. 11 shows a situation where a user (Taro) writes a query on the screen of the information retrieval system (ex. user device 331 of FIGS. 7 and 8) which is visible by other members in real time. Such a query is initially a simple form but is preferably converted to a colloquial form, i.e., a spoken language by the user device. For example, in FIG. 11, Taro may input a query “restaurant, breakfast, Redondo Beach” which is converted by the user device 331 to “searching for a good restaurant where I can have a good breakfast in Redondo Beach”.

In response, the other members send recommendations to Taro with respect to the search query in real time which are visible to all members involved. Each such recommendation written by other member is also initially a simple form but is preferably converted to a conversational form by the user device 331. All of the query by the user and the recommendations by the contacts of the social network (ex. people in address book) are visible on the screen of the user device 331 so that every participant knows what recommendation was made by who.

Referring to FIG. 12, the operational steps of the information search method shown in FIG. 11 is described where the process starts by inputting a search term by a searcher (user) at step 651. An input device such as a keyboard, a touch-screen, or a voice recognition device of the user device 331 of FIGS. 7 and 8 may be used in this step. Then, the process determines whether the search term indicates a search for location-based information in step 652. In this step, the information retrieval system (user device 331) may check if the search term is included in a list of location-based information keywords. For example, terms “restaurant” and “Redondo Beach” may be in a list of location-based information keywords.

Then, the method performs the steps of converting the collected search terms into a conversational format in step 653 as described with reference to FIG. 11. In the next step 654, the query in the conversational format is sent to an appropriate social networking service. The method of the present invention may determine an appropriate social networking service site based on the search term. For instance, if the search terms indicate a restaurant category, a social networking service that is strong in restaurant information may be selected or prioritized.

Through the social networking services, the search term in the conversational format is transmitted to the searcher's friends (ex. people in address book) who can respond to provide information to the searcher. In step 655, the method performs the steps of creating a location-based conversation medium/channel with the social network. The location-based conversation medium/channel with the social network allows interactive transmission of messages between the searcher and the other members.

In the next step 656, the process of the present invention receives recommendations from other members each of which is also in a conversational format as shown in FIG. 11. In this step for receiving recommendations from the members, such information as an action map, pictures, reviews, messages may be provided. For instance, the user may respond by sending a message “Catalina Coffee Company: Try tuna salad sandwich” or “Corner Bakery: Fresh cup of coffee and muffin or bagel” in response to the search of a good restaurant for a breakfast.

When two or more recommendations are received, in step 657, the process prioritizes the recommendations based on location such as an order of distance to the specified location. The step of prioritizing the recommendations based on location may take into consideration such factors as how close the searcher is relative to the user or the user's familiar area, how knowledgeable the user is about the subject being searched, and the user's preference, etc. Alternatively, the process may simply arrange the recommendations based on a time sequence of response, i.e., an order of the time received the recommendations.

The process outputs the recommendations (recommended places, reviews and location-based contents, etc.) in step 658 in a manner that everyone participating in the search can see the recommendations. An output device such as a monitor or display (ex. monitor 441 in FIG. 8) shows the recommended places, reviews and location-based contents, from which the user may select to view more detailed information or to set for route guidance. In this manner, the operation of searching the information from the members of social network is conducted while the members are communicating with one another in real time and the conversations in this transaction are visible to all of the members participating.

The step 653 noted above for converting the search term into a conversational format includes a step of determining the name of the searcher that is searching for a location-based information, determining the user's current location, determining the search term, and combining the name of the user, the user's current location, and the search term. For example, if a name of the searcher is John, and a search term is a Mexican restaurant, and a current location is determined to be in the city of Torrance, a sentence “John is looking for a Mexican restaurant in Torrance” can be generated. Likewise, if a name of the searcher is Mary, and a search term is a hair salon, and the current location is determined to be in the city of Los Angeles, “Mary says: I′m looking for a hair salon in downtown Los Angeles” will be generated and transmitted to friends of Mary in the common social networking service.

The current location can be automatically obtained by the GPS receiver or mobile phone tracking system, and the searcher is not required to manually input the current location. Thus, the search procedure can solicit information from friends through social networking service in response to a simple search term by the searcher. A friend receiving the conversational message may respond to the searcher, for example, by inputting a message that will be transmitted to the searcher.

As has been described above, according to the present invention, the search method and apparatus makes use of various contacts, i.e., human contacts in an address book, email, and social network, etc., as a means to find location, objects, people and relationship related to the contacts, thereby enhancing the search results. Namely, the search result is enhanced by incorporating human context or human relationship information, instead of solely searching general indexes. The search result is further enhanced by incorporating a user's information such as user's identity, preference, social networks, etc. with the search terms. More specifically, the search method and apparatus incorporates a contact name (“WHO”) with a generic search term (“WHAT”) such as location, object, etc., such that the search results are associated with the searcher's preference and human relationships. In a further aspect, the search method and apparatus creates a situation in which members of social networking service respond to a search request in real time in a visible manner by sending location-based information. Thus, in the present invention, it is possible to obtain more relevant and human context-based search results by incorporating the contact names into the search term to further retrieve information pertaining to the content of the user specified by the contact name and human relationships related to the user.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A computer implemented method of retrieving information, comprising the steps of:
receiving a search term specified by a searcher;
detecting whether WHO is specified in the search term to determine whether search should extend to human contacts in social networking services;
identifying WHAT from the search term and determining a nature of WHAT from the search term;
sending the search term to a social networking service to retrieve relevant information; and
presenting the retrieved information arranged in a predetermined order on a display or by audible sound;
wherein WHO is a name of contact representing a member of a social networking service and WHAT is a generic search term indicating a location or an object.

2. A computer implemented method of retrieving information as defined in claim 1, wherein WHAT is a location-based element, personal relationship, or a product.

3. A computer implemented method of retrieving information as defined in claim 1, further comprising a step of using location information of the searcher to arrange the retrieved information in the predetermined order.

4. A computer implemented method of retrieving information as defined in claim 1, wherein said location information of the searcher is determined by a GPS function of an electronics device operated by the searcher for pursuing the search.

5. A computer implemented method of retrieving information as defined in claim 1, further comprising a step of finding information of WHAT of a member of the social networking service directly or indirectly related to the contact represented by WHO.

6. A computer implemented method of retrieving information as defined in claim 1, further comprising a step of selecting an appropriate social networking service based on the search term for searching information related to the contact represented by WHO.

7. A computer implemented method of retrieving information as defined in claim 1, further comprising a step of crawling the social networking service to find information provided by members of social networking service directly of indirectly related to the contact represented by WHO.

8. A computer implemented method of retrieving information as defined in claim 1, further comprising the steps of:
converting the search term into a conversational format;
sending the conversational format of search term to members of a social networking service; and
receiving responses including recommendations from the members of the social networking service in real time in a visible manner.

9. A computer implemented method of retrieving information as defined in claim 8, wherein the step of converting the search term into conversational format includes the steps of:
determining a searcher's name;
determining a searcher's current location; and
combining the searcher's name, the search term, and the current location, thereby creating the conversational format.

10. A computer implemented method of retrieving information as defined in claim 8, further comprising a step of selecting an appropriate social networking service based on the search term for sending the conversational format to the selected social networking service.

11. A computer implemented apparatus for retrieving information, comprising:
means for receiving a search term specified by a searcher;
means for detecting whether WHO is specified in the search term to determine whether search should extend to human contacts in social networking services;
means for identifying WHAT from the search term and determining a nature of WHAT from the search term;
means for sending the search term to a social networking service to retrieve relevant information; and
means for presenting the retrieved information arranged in a predetermined order on a display or by audible sound;
wherein WHO is a name of contact representing a member of a social networking service and WHAT is a generic search term indicating a location or an object.

12. A computer implemented apparatus for retrieving information as defined in claim 11, wherein WHAT is a location-based element, personal relationship, or a product.

13. A computer implemented apparatus for retrieving information as defined in claim 11, further comprising means for using location information of the searcher to arrange the retrieved information in the predetermined order.

14. A computer implemented apparatus for retrieving information as defined in claim 11, wherein said location information of the searcher is determined by a GPS function of an electronics device operated by the searcher for pursuing the search.

15. A computer implemented apparatus for retrieving information as defined in claim 1, further comprising means for finding information of WHAT of a member of the social networking service directly or indirectly related to the contact represented by WHO.

16. A computer implemented apparatus for retrieving information as defined in claim 11, further comprising means for selecting an appropriate social networking service based on the search term for searching information related to the contact represented by WHO.

17. A computer implemented apparatus for retrieving information as defined in claim 11, further comprising means for crawling the social networking service to find information provided by members of social networking service directly of indirectly related to the contact represented by WHO.

18. A computer implemented apparatus for retrieving information as defined in claim 11, further comprising:
means for converting the search term into a conversational format;
means for sending the conversational format of search term to members of a social networking service; and
means for receiving responses including recommendations from the members of the social networking service in real time in a visible manner.

19. A computer implemented apparatus for retrieving information as defined in claim 18, wherein the means for converting the search term into conversational format includes:
means for determining a searcher's name;
means for determining a searcher's current location; and
means for combining the searcher's name, the search term, and the current location, thereby creating the conversational format.

20. A computer implemented apparatus for retrieving information as defined in claim 18, further comprising means for selecting an appropriate social networking service based on the search term for sending the conversational format to the selected social networking service.
